(19) United States
(12) Patent Application Publication
(10) Pub. No.: US 2006/0024551 A1
(43) Pub. Date: Feb. 2, 2006

(54) Array fuel cell reactors with a switching system

(75) Inventor: Eugene Smotkin, San Juan, PR (US)

Correspondence Address: MORRISON & FOERSTER LLP, 1650 TYSONS BOULEVARD, SUITE 300, MCLEAN, VA, 22102, US

(73) Assignee: NuVant Systems, Inc., San Juan, PR (US)

(21) Appl. No.: 11/061,483

(22) Filed: Feb. 22, 2005

Related U.S. Application Data
(60) Provisional application No. 60/545,898, filed on Feb. 20, 2004.

(51) Int. Cl. H01M 2/00

(52) U.S. Cl. 429/34

(57) ABSTRACT

A high throughput screening device for combinatorial chemistry having a plurality of flow channels, wherein a flow channel has a plurality of membrane electrode assemblies, and a switching system that permits a selected membrane electrode assembly in a flow channel to be in a current producing state at any time during operation of the high throughput screening device. This device obtains performance data from each and every array electrode simultaneously and does not require the movement of any electrode during data acquisition. Some application among many possible applications of the device of this invention is in the development and evaluation of catalysts (anode and cathode catalysts) for fuel cells and electrolysis systems. One embodiment of the invention relates to relates to an array fuel cell (FC) that has a multiple inlet gas fed array electrode flow field that permits the evaluation of 25 fuel cell electro-catalyst surfaces simultaneously or in groups.

### RELATED APPLICATIONS

This application claims benefit from U.S. provisional application No. 60/545,898, filed Feb. 20, 2004, entitled “Row Switching System for Fuel Cell Reactors.” This application is related to U.S. patent application Ser. No. 10/778,358, filed Feb. 17, 2004, entitled “High Throughput Screening Device for Combinatorial Chemistry,” which is a continuation-in-part of Ser. No. 09/907,628, filed Jul. 19, 2001, which claims benefit from U.S. provisional application No. 60/219,107, filed Jul. 19, 2000, entitled “Device For High Throughput Combinatorial Screening Of Bulk Electrocatalysts” and to PCT application No. PCT/US01/22137, filed Jul. 16, 2001 having the same title as the present application, the entire disclosures of which are hereby incorporated herein by reference.

### FIELD OF INVENTION

The present invention relates to an automated high throughput screening device, particularly, an array fuel cell (FC) that permits simultaneous evaluation of fuel cell membrane electrode assemblies (MEA) using a switching mechanism. The switching mechanism permits automated switching of a row or rows of the array fuel cell from an active state, i.e., current producing state, to an open circuit state, i.e., non-current producing state, or vice versa.

### BACKGROUND

Fuel cells are electrochemical devices that convert the chemical energy of a reaction directly into electrical energy. A fuel cell, although having components and characteristics similar to those of a typical battery, differs in several respects. The battery is an energy storage device. The maximum energy available is determined by the amount of chemical reactant stored within the battery itself. The battery will cease to produce electrical energy when the chemical reactants are consumed (i.e., discharged). In a secondary battery, recharging regenerates the reactants, which involves putting energy into the battery from an external source. The fuel cell, on the other hand, is an energy conversion device that theoretically has the capability of producing electrical energy for as long as the fuel and oxidant are supplied to the electrodes. There are two electrodes in the fuel cell, the anode where the fuel is oxidized and the cathode where oxygen from air is reduced. A fuel cell having one MEA is termed a single cell.

In reality, degradation of catalyst performance, corrosion, and/or malfunction of components limit the practical operating life of a fuel cell. The development of superior fuel cells requires the development of better catalysts. However, progress in the area of catalyst discovery and fuel cell development had been slow for a number of reasons, one of which was the lack of high throughput screening tools. To address this problem, the inventor of this application developed high throughput screening and analysis unit comprising an array of fuel cell reactors, for example, with 25 MEAs, including catalysts, diffusion backings and the electrolyte membrane

However, an array of fuel cell reactors has unique problems of its own: (1) How to design the flow of the reactant to the active array spots such that multiple array spots can be in an active operation without any impact on the performance of each of the active spots by another active spot? (2) How array spots can be independently switched on and off? (3) How to design a switching system such that when one fuel cell (or array spot) is active, e.g., Fuel Cell 1 (FC1), then all other fuel cells whose performance could be impacted by FC1 are in an inactive state? The inventor was first to recognize these problems and provide solutions in this invention.

### SUMMARY OF THE INVENTION

An object of the present invention is to solve problems with high throughput evaluation of MEA components that result from depletion of the reactant stream as it flows from array spot to array spot.

Additional advantages of this invention would become readily apparent to those skilled in this art from the following detailed description, wherein only the preferred embodiments of this invention are shown and described, simply by way of illustration of the best mode contemplated for carrying out this invention. As would be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 shows a schematic of a fuel cell not drawn to scale.

FIG. 2 depicts an exemplar fuel cell array of this invention containing 25 cells in five rows of five cells each.

FIG. 3 depicts an embodiment of the circuitry employed to affect the row switching of this invention.

FIG. 4 depicts an embodiment of the circuitry employed to affect the row switching of this invention.

FIG. 5 shows a gas fed array fuel cell ballast.

FIG. 6 is the engineering drawing for the ballast.

FIG. 7 is the engineering drawing of the array fuel cell end plate.

FIG. 8 shows the flow field block for the array side of the fuel cell of an embodiment of this invention.

FIG. 9 shows an embodiment of a test station having a 25-fuel cell array fuel system with row switching system.

### DETAILED DESCRIPTION

As used herein, the term “proton conductor” refers to any body capable of conducting protons. The body could be a single material or a composite material. A composite material is a materials system composed of a mixture or combination of two or more macro constituents differing in form and/or material composition and that are essentially insoluble in each other.

Fuel cells are energy conversion devices that convert chemical energy into electricity via electrochemical reactions. Fuel cells are typically categorized by the type of electrolyte used or the temperature range of operation. Polymer Electrolyte Fuel Cells (PEFC) use a proton conducting polymeric membrane (typically perflourinated sulfonated polymers such as Nafion™) as the electrolyte. These polymers are composed of a Teflon-like backbone supporting sulfonate groups in a channel-like interior. The sulfonate groups bond positively charged counter ions that are free to exchange. These free counter-ions provide the protonic conduction path.

The simplest type of PEFC uses hydrogen gas as a fuel. Hydrogen dissociates to protons and electrons at the fuel cell anode:
2H₂(g)→4H⁺+4e⁻
Oxygen serves as the oxidant and undergoes the cathodic half-reaction:
O₂(g)+4H⁺+4e⁻→2H₂O
The overall cell reaction produces water:
2H₂(g)+O₂(g)→2H₂O

The polymeric electrolyte (a proton conductor) conducts the protons generated in the anodic half-cell reaction to the cathode where they react according to the cathodic half-cell reaction. The polymer is an electronic insulator and an effective gas separator. Electrons generated at the anode follow an external electronic path to the cathode where they are consumed. The electronic current of the external path is typically used to do useful electronic work or to return power to the grid. Fuel and oxidant are supplied to the fuel cell anode and cathode respectively. The reversible potential difference between anode and cathode is 1.23 volts at standard conditions. As current is drawn the potential is reduced. Both cell half-reactions are catalyzed, typically by platinum. Ambient air may be used directly as the oxygen source. Both fuel and oxidant are typically fed in a humidified state, as hydration of the polymeric regions of the fuel cell is essential to maintaining good proton conductivity. Multiple fuel cells can be assembled in “stacks” to meet power requirements.

For purposes of this invention, a MEA comprises at least an electrode layer, e.g., an anode or a cathode, where a chemical entity is oxidized or reduced respectively, and a common electrode, e.g., a cathode or an anode, where an oxidant is reduced or a fuel is oxidized respectively. The MEA also has an electronically insulating proton conductor (EIPC), which conducts protons, but not electrons. The EIPC of this invention could be a separate component of the MEA or incorporated into a graded layer that is electronically insulating yet proton conductive on one face and a mixed electronic-protonic conductor on the opposite face. The mixed conductor region would serve as the catalytic region and the electronically insulating region would serve as the electrolyte or EIPC. A catalytic layer would be supported on the EIPC side of the graded layer. This would constitute a 2 layer MEA. This two-layer MEA would generally be operated at a high temperature such that one side of the proton conducting composite membrane of the MEA would not require a catalytic layer because the reaction at the uncatalyzed side is facile because of the high temperature. A generic representation for the MEA is: Anode/EIPC/Cathode. A two layer MEA would be one where one of the electrode regions has a gradually changing interface separating the EIPC region from the electrode region. This invention encompasses several embodiments of MEA.

Another embodiment of a two-layer MEA would be an electrode and a common electrode sandwiched together, wherein the interface between the electrode and common electrode forms an EIPC. An embodiment of a three-layer system would have an EIPC with catalytic layers of electrode and common electrode on both sides of the EIPC. The polymer electrolyte fuel cell MEA using Nafion with catalyst layers on both sides of Nafion is an example of a three layer MEA.

In another embodiment, a 5-layer MEA, an anode catalytic layer is supported on an EIPC, which in turn, is supported on a metal hydride foil. The face of the foil opposite the anode can have an EIPC layer deposited on the surface upon which is interfaced the cathode catalytic layer. Another embodiment, a 4-layer MEA, would have the EIPC on only one side of the metal hydride foil.

In general, an MEA is a component of a fuel cell, which includes the electrolyte system sandwiched between an anode and a cathode catalytic layer. The electrolyte system can include a matrix that supports a liquid phase electrolyte, a polymer phase, an inorganic phase that conducts oxide, carbonate or protons. The electrolyte can be a multicomponent system. The anode catalyst could be a high surface area platinum/ruthenium mixed metal catalyst (PtRu) and the cathode could be high surface area Pt black catalyst. The shorthand notation for a MEA having a PtRu anode, an EIPC and a Pt cathode is: PtRu/EIPC/Pt.

In a fuel cell, the polymer electrolyte membrane (e.g. Nafion in a polymer electrolyte fuel cell) is catalyzed on both faces. One face is the anode side where fuel is oxidized and the opposite face is the cathode side where oxygen is reduced. This three-layer system is commonly referred to as a membrane electrode assembly (MEA). The membrane electrode assembly is inserted into a fuel cell assembly. In one embodiment, the membrane assembly is a Nafion membrane electrolyte including the two catalytic layers that sandwich the membrane. There are two primary methods by which the catalysts can be incorporated into the fuel cell assembly. The catalyst can be (1) applied to a carbon diffusion layer or (2) applied to a membrane.

When the catalyst layer is applied to the carbon, the cell is assembled as follows: One of the graphite flow fields is laid upon a flat surface. The catalyzed carbon paper is laid upon the graphite flow fields with the catalyst layer facing upward. The Nafion layer is laid upon the catalytic surface. The next catalyzed carbon paper is laid upon the Nafion with the catalyst side placed in contact with the Nafion. The second graphite flow field is laid upon the unmodified surface of the carbon paper and the cell is then bolted together.

The catalyst can also be decal transferred to the Nafion layer by the method of M. S. Wilson et al., J. Appl. Electrochem., Vol. 22, 1 (1992). The cell is assembled in the same manner as above using pristine carbon diffusion layers.

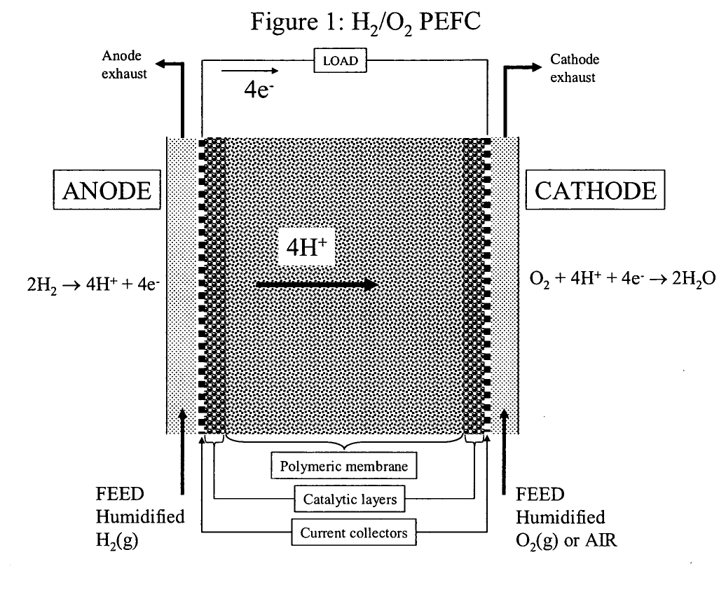

FIG. 1 is a cross-sectional view of a single-cell fuel cell illustrating its design and operation. Note the sandwich-like design (from left to right in the diagram): reactant/product path|porous electronic conduction path|anode catalytic layer|electrolyte|cathode catalytic layer|porous electronic conduction path|reactant/product path.

The embodiments of the invention relate to the following: an automated computer controlled device manipulating the potential of and monitoring the current produced by each element of a cell array (e.g., having 1-250 cells) of Polymer Electrolyte Fuel Cells; electronic switching circuitry designed to accept digital control signals from the computer interface facilitating incorporation of selected groups of cells into the array circuit in either predetermined and time dependant or manually operated schemes; and the generation of electrical power by PEFC. The operations are combined in such a manner as to facilitate rotation of array cell elements through open circuit and other potentials of interest without depletion of the fuel and oxidant gasses to downstream cell elements. Operation of an array of PEFC elements, without the negative effects of gas concentration depletion, provides distinct advantages when requiring uniformity when ranking the relative performances of the PEFC elements.

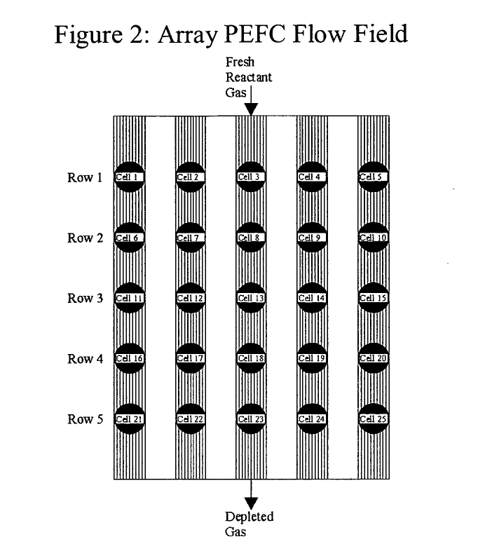

An embodiments of the invention incorporates an automated and computer controlled system to switch the cells that are current producing elements within an array of cells from this active state to an open circuit state. FIG. 2 of the attached figures depicts an exemplar fuel cell array of this invention containing 25 cells in five rows of five cells each. In an array of cells all of the cells are electrically in parallel. Kirchoff's laws imply that the potentials across circuits in parallel are equal while varying currents may flow down each branch. Thus, arrays of cells are of unique utility for examining the performance of different types of catalysts and the means by which the individual cells are prepared.

FIG. 2 illustrates an example of independent flow path of reactant gasses to the anode or cathode of the cells. The feed gas is distributed evenly through a manifold of five columns of narrow channels that flow across the catalytic surfaces of the cells. FIG. 2 also illustrates the drawback of an array fuel cell operation: when more than one row is in active operation the subsequent rows receive feed gas that has depleted reactant concentration. Mass transfer and kinetic considerations dictate that the performance of a fuel cell is dependant upon the concentration of the gas feed. Thus, when more than one fuel cell in a flow channel is in active operation the performance of the cells in the same flow channel cannot always be evaluated on the same basis. This is particularly true when the reactant concentrations are low or when the flow rates are low. Depletion of the reactant stream across the array will result in variations in performance that are not related to the intrinsic properties of the MEAs being evaluated.

Since construction of a manifold to feed all the cells (e.g. 25) separately and equally is costly and difficult, individual rows of cells are switched between the active and open circuit states to eliminate the influence of feed gas depletion upon the performance of subsequent rows. Automation of this switching process through a computer interface provides the means whereby operation of the device is reproducible and substantial labor savings are realized. The need for manual override of automated row switch control is recognized and provided for within the computer interface software. Also, the need for an ability to open all 25 circuits simultaneously is recognized and provided for with a single additional computer controlled switch.

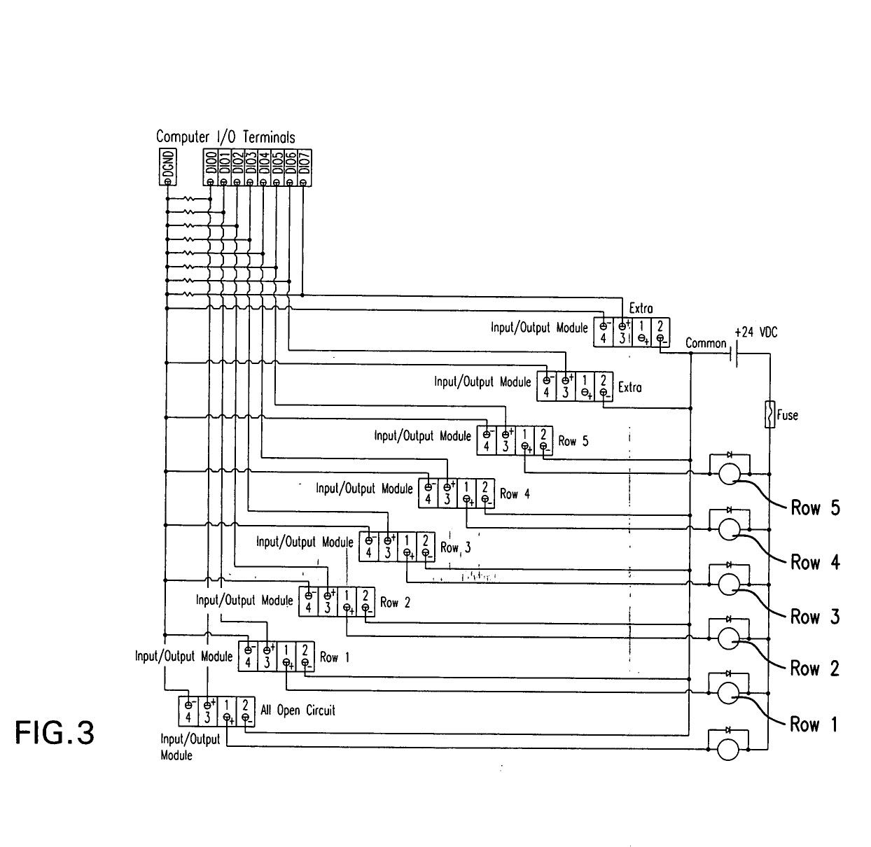

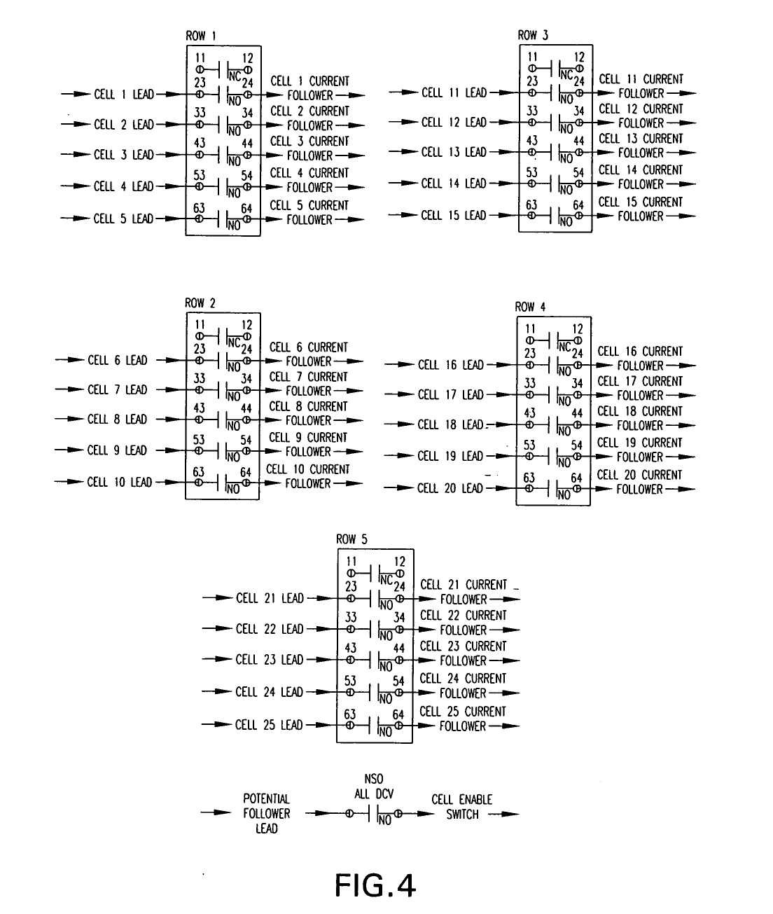

FIGS. 3 and 4 depict examples of the circuitry employed to affect the row switching of this invention to allow for individual rows of cells to be switched between the active and open circuit states to eliminate the influence of feed gas depletion upon the performance of subsequent rows.

The row switching circuitry is constructed from; 1) a computer whose digital outputs comprise the transistor logic (TTL) signals that are software driven in the manner described above; 3) a 24 VDC power supply; 3) input/output modules that convert microamp TTL signals from 5 VDC to 24 VDC with current levels sufficient to actuate electromechanical relays; 4) a bank of electromechanical relays connected in series and/or in parallel.

The switching circuitry of FIG. 3 can directly accept digital control signals from the computer interface and facilitate the incorporation of selected groups of cells into the array circuit in either predetermined and time dependant or manually operated schemes. The automated computer controlled equipment can manipulate the potential and monitor the current produced by each element of a 1-25 cell array of polymer electrolyte fuel cells.

In one embodiment, twenty-five of sensor electrodes are inserted into the twenty-five holes of a flow field block of the array of fuel cell reactors of FIG. 2. The sensor electrode is designed to fit into the holes of the block. The surface of the sensor electrode, which would be aligned with the linear flow field of the block has flow field grooves on the surface. In one embodiment, the grooves are 1/32″ wide. It is the grooves of the sensor electrode that will contact the GDLs of the array electrode region. The narrow side of the sensor electrode is threaded. The thread is designed to accommodate a screw lead that contacts a wire for delivery of current to the current follower. Each sensor electrode has a screw lead that electronically connects the sensor electrode to a current follower circuit.

Each sensor electrode could be connected to an electronic lead on the backside of the flow field block (i.e. the side opposite from the flow fields). The electronic lead from the sensor electrode could be attached to a current follower, which converts the current into a potential that can be sensed by a commercial data acquisition card. The data acquisition card.

Besides using the device of this invention for combinatorial chemistry to develop new catalysts, applicants found another important application for the device. A key area of fuel cell development, both reformate and direct methanol fuel cells, is the development of new membranes. With each new membrane comes the requirement for a new membrane electrode assembly (MEA) fabrication method. This will typically involve making a dispersion of the catalyst in a liquid consisting of ordinary organic solvents (e.g. alcohol, glycerol, etc) and some of the solubilized un-cross linked polymer used as the electrolyte. This dispersion is known as the catalyst “ink.” Optimizing the preparative method for ink is a complex, laborious process. The parameters that must be optimized include:
1) what ingredients should be included in the ink,
2) how much of each ingredient should be in the ink,
3) in what order should the ingredients be added,
4) what type of stirring should be done and
5) how long should the ink be stirred.
   This type of multi-parameter optimization is best addressed by preparative combinatorial methods, as this will dramatically reduce the time required for optimization. Given a new polymer membrane, 25 different ink preparative methods can be tried by the array of fuel cells of FIG. 2.

One embodiment of the invention relates to relates to an array fuel cell (FC) that utilizes a counter electrode flow field and a multiple inlet gas fed array electrode flow field that permits the evaluation of 25 fuel cell electro-catalyst surfaces simultaneously or in groups. The catalysts can be anode or cathode electro-catalyst candidates. Variations of catalysts compositions and/or methods of preparation can be evaluated in a high throughput mode using this gas fed array fuel cell.

High throughput screening methods require uniform conditions for all candidates being evaluated to avoid false positives, which can mislead the path of discovery of new materials or specifically catalysts in this case. The previous embodiments evaluate catalyst candidates for a liquid feed system specifically a Direct Methanol Fuel Cell (DMFC), though it could be applicable to a gas feed stream too. The row switching system of this invention allows each fuel cell to be exposed to a feed stream having substantially uniform concentration of the fuel, which is particularly difficult to maintain throughout the 25 catalyst array flow field under conditions of certain flow rates and stoichiometric ratios of gaseous feed stream. The stoichiometric ratio is defined as the ratio of the molecules delivered to the reactant surface per unit time, divided by the number of molecules consumed by the electrochemical reaction at the reactant surface per unit time. Gases are compressible fluids and the array flow field is not generally workable without the switching system of this invention because it results in pressure drops and non-uniform conditions across the flow field. Also, hydrogen air fuel cells are typically higher power units than liquid feed direct methanol fuel cells. So more of the reactant stream is consumed by the electrochemical reaction. Thus, this invention uses parallel streams in the gas fed array fuel cell in conjunctions with the row switching system for maintaining a substantial uniform concentration of hydrogen at the reactant surface of each fuel cell across the flow field.

The gas fed array fuel cell the array fuel cell flow field could be segmented into 5 different channels and every channel could have an isolated inlet and outlet. The 5 inlets could be connected to large volume ballast, which acts as common reservoir for one or more reactants entering the inlet channels. Due to the large free volume in the ballast pressure across the width of ballast becomes uniform and uniform flow is obtained in the multiple channels exiting the ballast and entering the fuel cell through multiple inlets in the array fuel cell end plate.

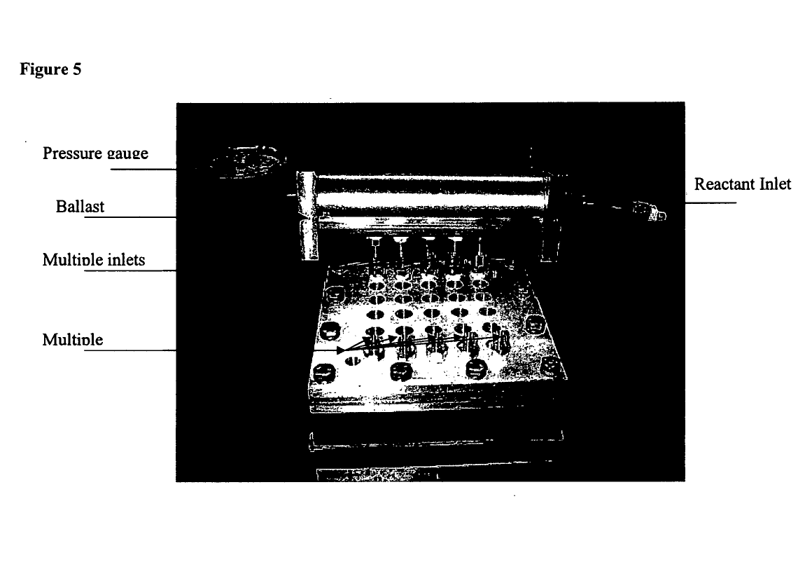

In an embodiment of a gas fed array fuel cell, the reactant enters the fuel cell through large volume ballast attached to the fuel cell endplate as shown in FIG. 5. The fuel cell includes an external ballast attached to the array side fuel cell end plate, the array fuel cell ceramic flow field, the Membrane Electrode Assembly (MEA) and the counter reference electrode with its end plate. The MEA preparation method and the counter reference electrode with its end plate remain unmodified in its design as explained above. The modifications include the addition of an external reactant reservoir ballast with 5 NPT thread outlets connecting 5 NPT thread inlets on the array fuel cell end plate for a Swagelok-Swagelok fitting between the ballast and endplate and a multi channel array fuel cell flow field with isolated inlets and outlets for all 5 channels to provide for measurement of flow in each of the channels.

With some modifications, as detailed below, the array fuel cells with the row switching system can be used for high throughput electrosynthesis. For example, a 25-channel potentiostat can be used for parallel screening of all components of 25 MEAs, including catalysts, the choice of carbon fabric and the type of PEM selected. In addition, data acquisition software could facilitate the control of process parameters such as electrodes potentials, cell temperature and reactant flow, and data acquisition/analysis.

The “row-switching” system of this invention makes the array catalyst evaluation instrumentation uniquely suited for application to electrosynthesis applications, for example, for an array of 25 fuel cell reactors as shown in FIG. 2, which shows 5 cells per row and 5 cells per flow channel. The row switching technique was developed to address the problem of reactant stream depletion along the flow channel. Using software controlled switches any row can be isolated while all other rows are held at open circuit. With the “row switching” system, combined with selection of the output channel the reactions occurring in any particular cell can be isolated for study. The area of each catalyst spot (˜0.70 cm²) is sufficient to allow the reaction products to be analyzed by in-line mass spectroscopy or gas chromatography analysis. Thus, the reaction products of each cell can be studied in an automated manner, permitting screening of catalysts for electrosynthesis of fine chemical. One application of the array fuel cells with the switching system could be fine chemical electrosynthesis research and development. The use of the fuel cell reactor enables these processes to be carried out in a solvent less manner.

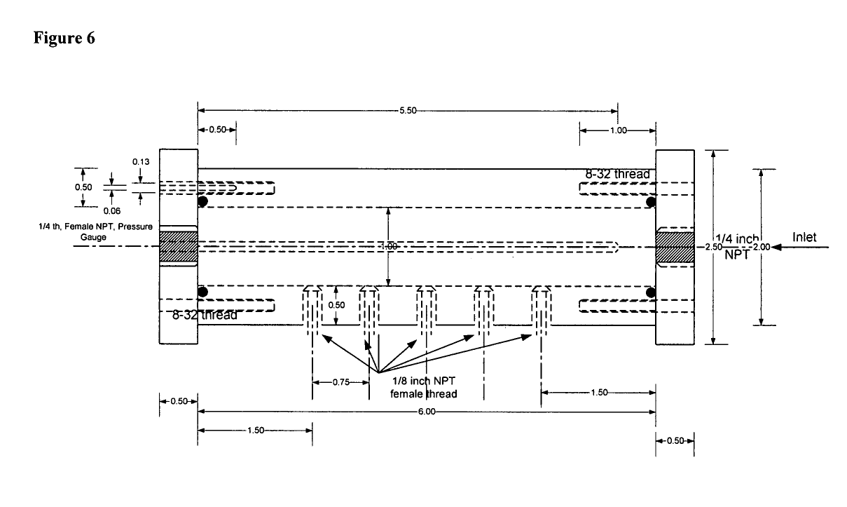

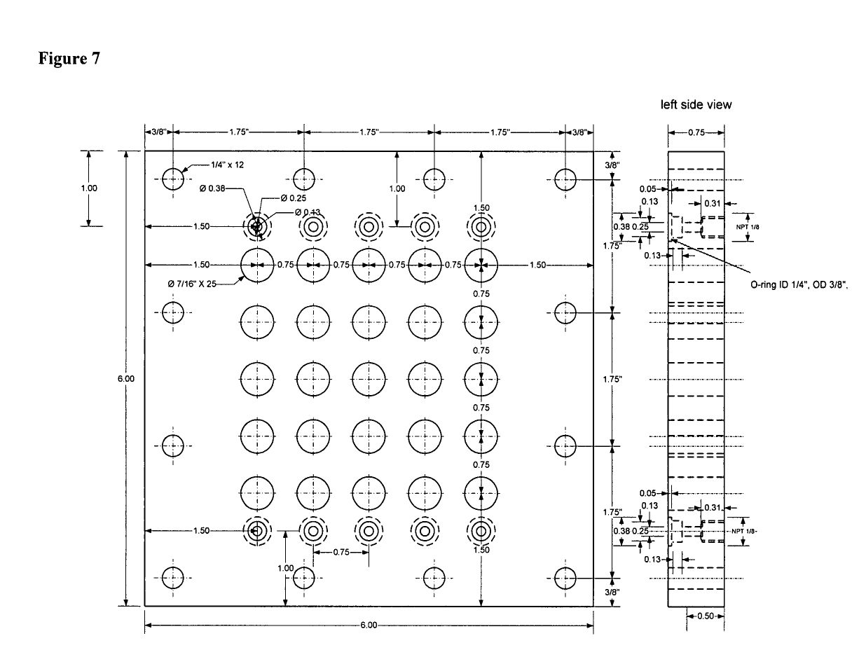

FIG. 6 and FIG. 7 are the engineering drawings for the ballast and the array fuel cell end plate respectively. The “ballast” is a 1-inch diameter, 0.5-inch thick cylindrical Aluminum vessel with five outlets, which gets directly attached to five inlets on the end plate of the array fuel cell. The ends of the cylinder are closed with Aluminum plate covers using an o-ring and 4 hex socket head cap screws on both ends. The inlet reservoir (“ballast”) has a quarter inch NPT thread for inlet on one end and NPT thread for a pressure gauge on the other to monitor pressure at the inlet. The five multiple outlets from the ballast connect to the array fuel cell end plate using Swagelok fittings. An outlet is also provided for every flow channel so that flow across every channel in the flow field can be measured. The ballast is provided with ⅛^{th} inch diameter heater cartridges and a 1/16^{th} inch thermocouple to temperature control the inlet manifold. These dimensions could however be sized appropriately for a different size array fuel cell.

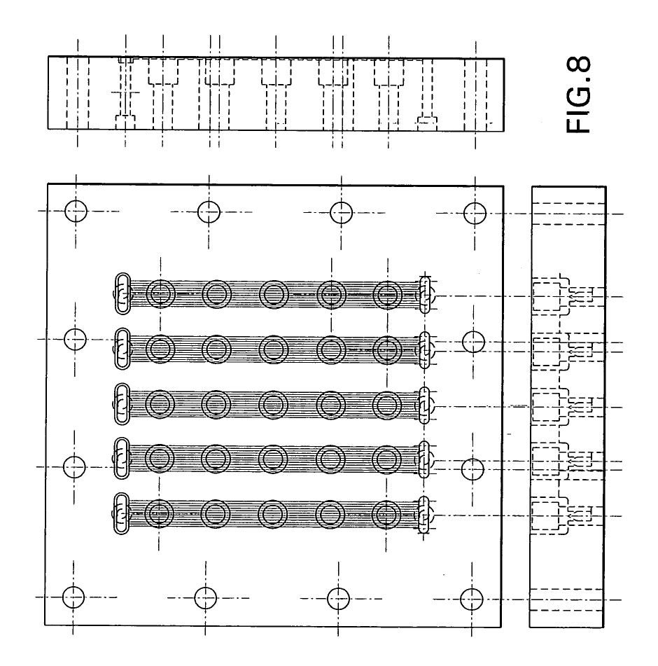

FIG. 8 shows the flow field block for the array side of the fuel cell of this embodiment. The array block comprises a non-conductive material such as ceramic. One criteria for the selection of the material is that the material be not electronically conducting and that the material has an expansion coefficient not too different from graphite as when the cell is heated to the operating temperature (between 40° C. and 100° C.) the assembly tends to distort from the configuration it had when bolted together at room temperature. The block has 25 holes in it where sensor electrodes are glued in. The sensor electrodes are graphite sensor electrodes with miniature flow fields incorporated on the surface of the sensor electrodes as in the previous embodiments. There are 5 channels with flow field grooves as shown in FIG. 8 that connect the 5 electrodes in series. Every channel has its own inlet and outlet NPT thread fitting which is a different feature of the array flow field of this embodiment as compared to our previous embodiments having a serpentine array flow field primarily for liquid feed systems where only a single inlet and outlet are used. The flow in every channel can thus be isolated and measured individually to confirm uniformity of flow. The holes are meant to accommodate the press fitting or gluing of the sensor electrodes.

In the current flow field the grooves are 1/32″ wide. It is the grooves of the sensor electrode that would contact the GDLs of the array electrode region. The narrow side of the sensor electrode is threaded. The thread is designed to accommodate a screw lead that contacts a wire for delivery of current to the current follower. Each sensor electrode has a screw lead that electronically connects the sensor electrode to a current follower circuit, which converts the current into a potential that can be sensed by a commercial data acquisition card. The data acquisition card used in this embodiment could be a National Instruments card.

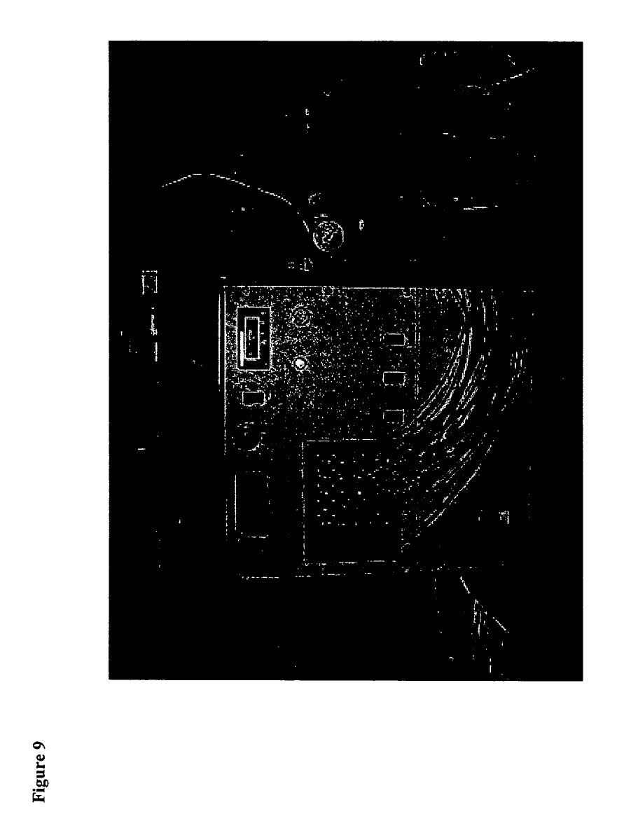

To integrate the row switching manipulation with electrochemical measurements and parameter controls, this invention could use software control for the gas fed AFC. The software could have multifunction and visualize the parameters control and monitor the process parameters. Polarization curves, voltammograms, chronoamperograms and chronopotentiograms could be conveniently obtained using this new software. Activity evaluation and characterization of electrocatalysts could be simultaneously obtained. An embodiment of a test station having a 25-fuel cell array fuel system with row switching system for high throughput screening of 25 catalysts simultaneously is shown in FIG. 9, where the unit on the left is high throughput screening unit having the row switching system while the unit on the right with the pressure gauge is the 25-cell array of fuel cells. At the top left and right of the high throughput screening unit are potential and temperature displays.

Briefly, the specification of the high throughput screening unit of FIG. 9 are the following:
(1) Channel inputs: 25
(2) Potential range: +/−3 Volts, resolution 0.5 mV
(3) Total current range: 15 Amp
(4) Current per channel: 600 mA, resolution 1.5 mA
(5) Temperature controller: Auto tune PID controller with K-type thermocouple
(6) Row switching system for low fuel and/or oxidant stoichiometric ratios

The applications of the high throughput screening unit of FIG. 9 include, for example: (1) fuel cell catalyst screening, (2) polymer electrodes, (3) electrochemical sensors, (4) electrosynthesis catalysts, (5) gas diffusion layer (GDL) materials, and (6) fuel cell catalysts ink formulations.

Optionally, the device of FIG. 9 could include a fuel/gas delivery system for direct methanol fuel cell (DMFC), which could include a mass flow controller for air delivery and a pump for methanol fuel delivery. Further optionally, the device of FIG. 9 could include a fuel/gas delivery system for hydrogen/air fuel cell, which could further include a humidifier and mass flow controller for hydrogen, air and reformate simulant delivery.

### EXAMPLES

Conditioning of an Array of 25 PEFC: The rows of cells are brought to predetermined potentials for predetermined periods of time. Because the cells have not yet reached steady state operation, it is not possible to gather reproducible data of cell performance. Hence, during cell conditioning, all the cells will be maintained in their active state.

Performance testing of an array of 25 PEFC: One or more row of cells, predicated upon the reactant flow rates and predicted reactant consumption, is switched into the active state and the potential will be varied and the resultant currents measured. Since the amount of time spent at open circuit influences the performance of PEFC, the computer automation interface is used to rotate rows of cells through active state measurements in a reproducible manner without the requirement for operator intervention.

The above description is presented to enable a person skilled in the art to make and use the embodiments of the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Finally, the entire disclosure of the patents and publications referred in this application are hereby incorporated herein by reference.

1. A high throughput screening device for combinatorial chemistry, comprising:
a flow field block comprising a flow channel comprising a plurality of membrane electrode assemblies, and
a switching system that causes a selected membrane electrode assembly to be switched on into a current producing state or switched off independently from any other membrane electrode assembly in the flow channel during operation of the high throughput screening device.

2. The device of claim 1, wherein the flow field block comprises a plurality of flow channels having inlets to the flow channels.

3. The device of claim 1, wherein each membrane electrode assembly does not have a separate feed manifold.

4. The device of claim 2, wherein the switching system causes only one membrane electrode assembly in a particular flow channel to be in a current producing state during operation of the high throughput screening device.

5. The device of claim 1, wherein the switching system comprises switches and a computer whose output comprises signals for actuating the switches to independently permit any one of the plurality of the membrane electrode assemblies to be in either a current producing state or a non-current producing state.

6. The device of claim 5, wherein the switches are electromechanical relays.

7. The device of claim 6, further comprising an input/output module.

8. The device of claim 7, wherein the signals are transistor logic signals and the input/output module converts the transistor logic signals into signals with a current level sufficient to actuate the electromechanical relay.

9. The device of claim 1, wherein the device further comprises a catalyst.

10. The device of claim 1, wherein the membrane electrode assembly comprises an electrolyte layer and two catalyst layers.

11. The device of claim 2, wherein the plurality of flow channels are substantially parallel.

12. The device of claim 1, further comprising a sensor electrode.

13. The device of claim 2, further comprising an external reservoir attached to the device to create a substantially uniform pressure of a fluid at the inlets.

14. The device of claim 13, wherein the fluid is a gas.

15. The device of claim 13, wherein the device evaluates electro-catalysts simultaneously or in groups.

16. An array fuel cell comprising multiple inlet gas fed flow channels comprising a plurality of fuel cell reactors and a switching system that causes a selected fuel cell reactor to be switched on into a current producing state or switched off independently from any other fuel cell reactor in the array fuel cell during operation of the array fuel cell.

17. The array fuel cell of claim 16, wherein the switching system causes only one fuel cell reactor in a particular flow channel to be in a current producing state during operation of the high throughput screening device.

18. The array fuel cell of claim 16, wherein the switching system comprises switches and a computer whose output comprises signals for actuating the switches to independently permit any one of the plurality of the fuel cell reactors to be in either a current producing state or a non-current producing state.

19. The array fuel cell of claim 18, wherein the switches are electromechanical relays.

20. The array fuel cell of claim 19, further comprising an input/output module, wherein the signals are transistor logic signals and the input/output module converts the transistor logic signals into signals with a current level sufficient to actuate the electromechanical relay.
